(19) United States
(12) Patent Application Publication
(10) Pub. No.: US 2003/0086847 A1
(43) Pub. Date: May 8, 2003

(54) Flood-limiting devices for gas-liquid reactors

(76) Inventors: Achim K. Heibel, Corning, NY (US); Joshua A. Jamison, Painted Post, NY (US)

Correspondence Address: CORNING INCORPORATED, SP-TI-3-1, CORNING, NY, 14831

(21) Appl. No.: 10/184,363

(22) Filed: Jun. 26, 2002

Related U.S. Application Data
(63) Continuation-in-part of application No. 10/012,789, filed on Nov. 5, 2001.

(51) Int. Cl. B01J 8/02

(52) U.S. Cl. 422/222; 422/211

(57) ABSTRACT

A device for extending a flooding limit of a packed column includes a stack of monolith segments having a plurality of channels. The monolith segments are stacked in order of decreasing channel diameter in the direction of liquid flow into the column, the increasing channel diameters toward the top of the stack acting to effectively increase the inlet channel diameter of the column.

### CROSS-REFERENCE TO RELATED APPLICATIONS

This application is a continuation-in-part of U.S. patent application Ser. No. 10/012,789, filed Nov. 5, 2001.

### BACKGROUND OF THE INVENTION

The present invention relates generally to devices and methods for expanding the operating window of multiphase reactors or gas-liquid contactors operated under countercurrent flow conditions. Gas-liquid contactors include devices such as distillation columns, strippers, saturators, absorbers, evaporative coolers, heaters or other devices widely used in industry for the purpose of exchanging mass or energy between gas and liquid phases in fluid processing streams.

Multiphase reactors or gas-liquid contactors operated under countercurrent flow conditions are typically required to be free of flooding for a specified operating window, i.e., a specified range of gas and liquid flow rates. Flooding refers to a phenomenon by which gas moving in one direction in a packed column entrains liquid moving in the opposite direction in the packed column. Flooding is undesirable because it can cause a large pressure drop across the packed column as well as other effects that are detrimental to the performance and stability of the reactor. In practice, there is usually a tradeoff between the geometrical requirements desirable for the reaction or mass transfer performance of the reactor and the restrictions to allow a wide-enough operating window without flooding. In some cases, the operating window can be expanded by enhancing the countercurrent flow characteristics at the inlet and/or outlet of the packed column. The following discussion examines monolith reactors and various methods used in enhancing countercurrent flow characteristics at the inlet and/or outlet of the monolith.

Monoliths such as employed as packing elements in monolithic reactors comprise a large assembly of thin, parallel, straight channels through which fluids, i.e., gas and liquid, can flow. The number of channels in relation to the cross-sectional area of the monoliths is referred to as cell density. The cross-section of the channels can be of any arbitrary shape, such as square, rectangular, triangular, hexagonal, circular, etc. Longitudinal fins may also be incorporated in the walls of the channels to increase the surface area of the channels. Monoliths are typically extruded from a ceramic material such as cordierite but may also be manufactured from metal. The walls of the monolith channels may be coated with a porous washcoat containing an active catalyst. Alternatively, an active catalyst may be incorporated into the walls of the monolith channels. In operation, fluids containing reactants flow through the monolith channels. The reactants react in the presence of the active catalyst, and the products of the reaction are transported out of the monolith channels.

Under countercurrent flow conditions, liquid flows down as a wavy falling film on the wall of the monolith channel while gas travels up through the core of the channel. At flooded conditions, liquid slugs are transported upward, which results in a large pressure drop across a monolith bed. Flooding is mostly introduced at the inlet and outlet of the monolith bed as well as in stacking zones between monolith segments. At lower liquid velocities, the flow phenomena at the outlet end of the monolith bed tend to dominate. At higher liquid velocities, the effects near the inlet end of the monolith bed gains significance. The liquid entering a monolith channel can form a bridge between walls adjacent to the channel, thereby blocking the inlet of the channel. FIG. 1 shows liquid 52 forming a bridge between walls 54, 56. A bridge formed between walls 54, 56 will block the inlet of the channel 58 and prevent gas 59 from flowing through the inlet of the channel 58. This may result in higher gas flow rates in channel 58 and may lead to flooding further downstream in the reactor. In practice, the geometry of the monolith reactor is such that flooding is avoided for the operating window of the monolith reactor. However, a channel geometry that avoids flooding may not provide the desired reaction performance.

Flexibility in the selection of the appropriate channel geometry for an application may be attained by enhancing the countercurrent flow characteristics of the reactor. One method for enhancing countercurrent flow characteristics involves beveling the outlet end of the monolith channels at an angle, typically at 70° perpendicular to the flow direction. See, Lebens, P. J. M et al., “Hydrodynamics of gas-liquid countercurrent flow in internally finned monolithic structures,” Chemical Engineering Science, Vol. 52, Nos. 21/22, pp. 3893. Another method for enhancing countercurrent flow characteristics involves aligning a set of parallel plates with the monolith channel walls. The parallel plates have nibs which act as drip points for liquid drainage. See, Lebens, P. J. M. et al., “Hydrodynamics and mass transfer issues in a countercurrent gas-liquid internally finned monolith reactor,” Chemical Engineering Science, Vol. 54, pp. 2383. Typically, the parallel plates with nibs work well when the cell density of the monolith is low. Guiding of the liquid to the nibs and dripping becomes more difficult when the cell density of the monolith is high, e.g., greater than 50 channels per square inch of cross-sectional area (cpsi).

The flooding restrictions at the inlet and outlet ends of monolith catalyst beds are in fact reasonably representative of those for other packed beds such as packed catalyst pellet bed reactors operated in counter-current flow. Therefore an improvement in these areas can lead to an overall improvement of the operating window of the entire column. This is especially the case for structured packings.

### SUMMARY OF INVENTION

In an important aspect, then, the invention relates to a device for extending a flooding limit of a packed column in a multiphase reactor or gas liquid contactor. More particularly the invention relates to a device positioned at the inlet to the column bed comprising one or a plurality (stack) of monolith(s) or other inlet structures with open passages oriented towards the main flow direction of the liquid into the column, and the use of such a device to expand the flooding limit of the packed column. These flood-limiting devices preferably have large openings (e.g. channels with a large effective channel diameter) at the top of the structure or stack, more particularly top openings having a larger effective channel hydraulic diameter than that of the packing in the column. Thus the devices retard the onset of flooding due to inlet effects and raise the typical flooding point of the bed itself. Suitably, the effective channel hydraulic diameter is gradually or step-wise reduced within the device toward the typical hydrodynamic dimensions (effective channel hydraulic diameters) of the column packing, which for the case of a honeycomb monolith packing corresponds to the hydraulic diameters of the honeycomb monolith channels, and for the case of pellet, bead or other packed bed designs the characteristic hydraulic length dimensions of the tortuous flow path.

Generally, these devices are characterized by a high void fraction to maximize the volume for the fluid phases, and are typified by a channeled structure that decreases in channel cross-section and thus effective hydraulic diameter in the direction of fluid flow in a manner that prevents bridging of the fluid at the inlet of the packed column for a predetermined range of fluid velocities. A stack of monolithic honeycomb segments that increases in cell density and decreases in channel cross-section (and thus effective channel hydraulic diameter) in the direction of liquid flow into the stack is a typical device.

In another aspect, the invention relates to a countercurrent reactor which comprises a packed column and a flood limiting device comprising one or a plurality (stack) of monolith segments or other channeled structures mounted at an inlet of the packed column through which a fluid can be conveyed into the packed column. The openings or channels in the stack will have a decreasing hydraulic diameter in the direction of fluid flow and prevents bridging of the fluid at the inlet of the packed column for a predetermined operating window of the reactor.

In yet another aspect, the invention relates to a method for expanding a flooding limit of a packed column which comprises passing a fluid through a flood limiting device comprising one or a plurality (stack) of monolith segments or other channeled structures mounted at an inlet of the packed column, the device having a decreasing hydraulic diameter into an inlet of the packed column.

Other features and advantages of the invention will be apparent from the following description and the appended claims.

### BRIEF DESCRIPTION OF DRAWINGS

FIG. 1 shows liquid bridging at the inlet of a monolith channel.

FIG. 2 shows a flood limiting device according to an embodiment of the invention mounted at an inlet end of a monolithic reactor or gas-liquid contactor bed.

FIG. 3 shows an enlarged view of the flood limiting device of FIG. 2.

FIG. 4 shows a monolith bed incorporating a flood limiting device at the outlet end as well as at the inlet end of a monolithic reactor or contactor bed.

FIG. 5 shows an enlarged view of a typical outlet device to limit outlet-induced flooding mounted at the outlet end of the monolith bed of FIG. 4.

FIG. 6A shows a monolith bed without a flood limiting device mounted at its inlet end;

FIG. 6B shows a monolith bed including a flood limiting device mounted at its inlet end; and

FIG. 7 shows flooding limits as a function of superficial gas and liquid velocities for the monolith reactor configurations shown in FIGS. 6A and 6B.

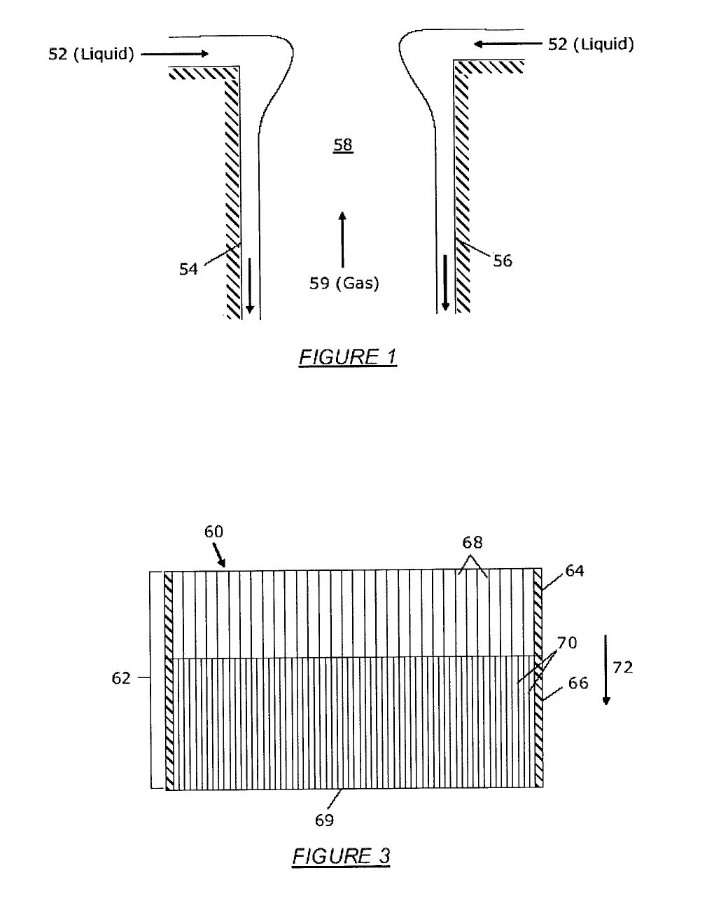

### DETAILED DESCRIPTION

Embodiments of the invention provide an inlet device that improves the flooding performance of a reactor (or contactor) operated under countercurrent flow conditions. The inlet device, when mounted at an inlet end of a packed column, prevents bridging effects at the inlet end of the packed column, thereby preventing flooding at the inlet end of the packed column and expanding the operating window of the reactor. As an option, an outlet device, similar in structure to the inlet device but with the direction of hydraulic diameter change reversed, can also be mounted at an outlet end of the packed column to assist in draining fluid out of the packed column, such an outlet device acting to suppress flooding that might otherwise originating at the outlet end of the packed column.

The particular geometry of the inlet device selected for use in accordance with the invention will of course depend in part on-the geometry and flow characteristics of the underlying reactor or contactor bed(s). Hydraulic diameters monolith beds will typically range from about 1 to about 20 mm, with a void fractions of from 20-85% depending upon the thickness of the walls separating the monolith channels. For packed bead or pellet beds, typical equivalent particle diameters will be from about 1 to about 10 mm with a void fraction from 30-50%. For either of these reactor or contactor beds, hydraulic diameters of from 2 to 50 mm for the top layer of the inlet device, with void fractions of from 40-95% for that layer, will be suitable.

Specific embodiments of the invention will now be described with reference to the accompanying drawings. While the invention is described below with reference to a monolith bed, it should be clear that the invention is not limited to monolith beds or structured packings. The invention could be applied to packed beds with conventional catalyst pellets, for example.

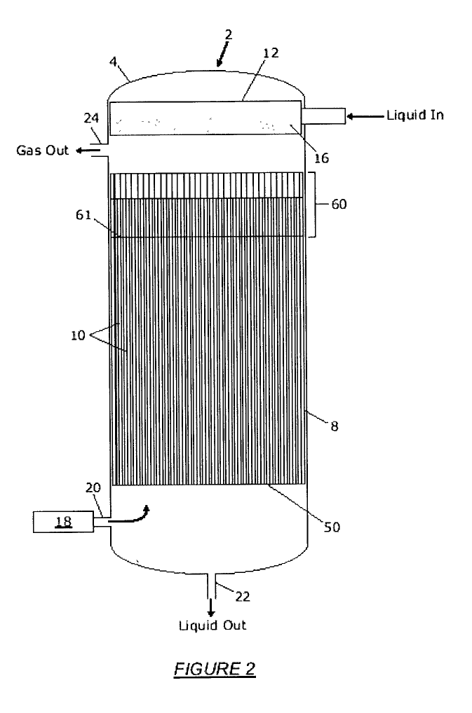

FIG. 2 shows a reactor 2 incorporating an embodiment of the invention. The reactor 2 includes a reactor housing 4 inside which is disposed a column packing consisting of monolith bed 8. The monolith bed 8 has a plurality of channels 10 through which fluids can flow. The walls of the channels 10 may be coated with a porous oxide (washcoat) containing catalytic species, or catalytic species may be incorporated directly into the walls of the channels 10. Longitudinal fins (not shown) may also be incorporated in the walls of the channels 10 to increase the surface area of the channels 10.

In countercurrent operation, a liquid distributor 12 mounted above the column packing (e.g., monolith bed 8) distributes a liquid reactant 16 into the channels 10 in the monolith bed 8. Examples of liquid distributors include, but are not limited to, sparger pipe, sieve tray, trough, picket-fence weir, bubble cap, spray nozzle, shower head, and overflow tube type. The liquid reactant 16 flows down the channels 10 as a wavy liquid film. A gaseous reactant 18 is introduced below the monolith bed 8 through one or more ports 20 in the reactor housing 4. The gaseous reactant 18 flows up through the cores of the channels 10. The byproducts of the reaction between the liquid reactant 16 and the gaseous reactant 18 can be discharged from the reactor housing 4 through the ports 22 and 24.

A flood limiting inlet device 60 is positioned above the monolith bed 8 to prevent the bridging effects at the inlet end 61 of the monolith bed 8. FIG. 3 shows an enlarged view of one example of such an inlet device 60, the device in this case consisting of a stack 62 of monolithic honeycomb segments 64, 66. Typically, the monolith stack 62 includes two or more monolith segments (or segments of other structures with open channels in the direction of fluid flow,) although a single monolith segment may also be used. The monolith segments 64, 66 have a plurality of channels 68, 70, respectively, through which fluids can flow. The dimensions and shapes of the channels 68, 70 are such that they have limited flow capacity in a non-flooded regime of the monolith bed (8 in FIG. 2).

Typically, the monolith segments 64, 66 have different cell densities, where cell density is the number of channels per cross-section area of the monolith segment. The monolith segment 64 at the top of the stack 62 has a larger channel diameter than the monolith segment 66 at the bottom of the stack 62. In general the monolith in the stack should have a high voidage. In special cases the monolith segment 64 at the top of the stack 62 has a higher open frontal area than the monolith segment 66 at the bottom of the stack 62. The term “open frontal area,” as used herein, refers to the part of the cross-sectional area of the monolith or other structure that is available for the flow of fluid. Typically, it is desirable that the effective channel hydraulic diameter of the flood-limiting device decrease in the direction of liquid flow into the reactor or contactor, i.e., increase up the stack 62 in the direction shown by the arrow 72. Preferably, the channel diameter increase up the stack 62 is gradual. The channel diameter of the monolith segment 64 at the bottom of the stack 62 may be the same or may be larger than the channel diameter of the monolith bed (8 in FIG. 2).

The inlet device 60 may be integrated in a support grid (not shown) used to fix the monolith bed (8 in FIG. 2) in the reactor housing (4 in FIG. 2). Preferably, the upper and lower surfaces of the monolith segments 64, 66 are such that the monolith segments 64, 66 make full contact with each other when stacked together. Typically, this involves flattening the upper and lower surfaces of the monolith segments 64, 66. Flattening the interfaces between the monolith segments 64, 66 enhances the operating window of the reactor. Preferably, the lower surface 69 of the monolith segment 66 at the bottom of the stack 62 is such that it makes full contact with the inlet end 61 of the monolith bed (8 in FIG. 2).

Returning to FIG. 2, the inlet device 60 prevents bridging effects, i.e., blocking of channels 10, that can cause flooding at the inlet 61 of the monolith packing 8 and further downstream the monolith packing 8. However, especially in the case of a reactor or gas-liquid contactor employing a monolithic packing 8, flooding can still occur at the outlet 50 of the monolith packing 8 if the fluid is not effectively drained out of the channels 10. Thus in one embodiment of the invention an optional flood limit expander that is an inverted form of the inlet device 60 can be mounted at the outlet 50 of the monolith packing 8 to improve fluid drain from the channels 10 and thereby suppress flooding initiated at the packing outlet 50.

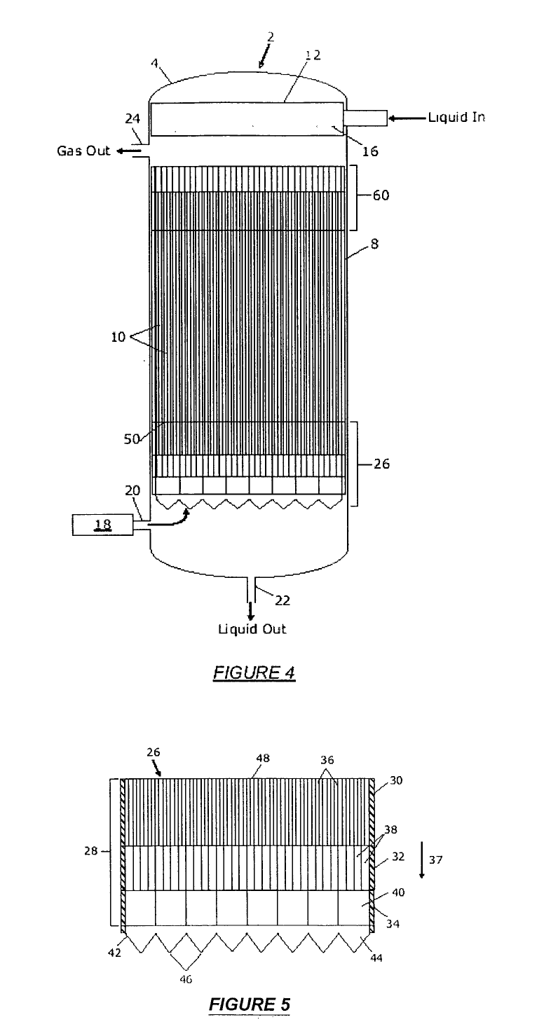

FIG. 4 shows an example of this embodiment wherein an optional outlet flooding limit expander (“outlet device”) 26 is positioned below the monolith packing 8 to assist in draining liquid out of the monolith packing 8. FIG. 5 shows an enlarged view of a suitable outlet device 26. The outlet device 26 includes a monolith stack 28 having monolith segments 30, 32, 34. Typically, the monolith stack 28 includes two or more monolith segments, although a single monolith segment may also be used.

The monolith segments 30, 32, 34 have a plurality of channels 36, 38, 40, respectively, through which fluid can flow, and the monolith segments 30, 32, 34 have different cell densities, with the hydraulic diameter of the channels in the monolith segment 32 is larger than the hydraulic diameter of the channels in the monolith segment 30, and the hydraulic diameter of the channels in the monolith segment 34 is larger than the hydraulic diameter of the channels in the monolith segment 32 so that the channel diameter will increase in the direction in which liquid flows out of the packed column, i.e., down the stack, as shown by the arrow 37. The hydraulic diameter of the channels in the monolith segment 30 at the top of the stack 28 may be the same or may be larger than the hydraulic diameter of the channels in the monolith packing (8 in FIG. 4). Of course, the use of such outlet devices is not limited to this particular device, and any of a variety of other designs including any of those disclosed in copending commonly assigned U.S. patent application Ser. No. 10/012789 filed Nov. 5, 2001, entitled “Monolith Stacking Configuration For Improved Flooding” and expressly incorporated by reference herein, may alternatively be employed for this purpose.

The following examples illustrate the advantageous flood-limiting performance of one embodiment of a device provided in accordance with the invention. In this particular case, presented for illustrative purposes only and not to be constructed as limiting the invention, the device consists of a stack of monolithic honeycomb segments that is particularly effective for expanding column flooding limits near the upper liquid flow capacity of the column.

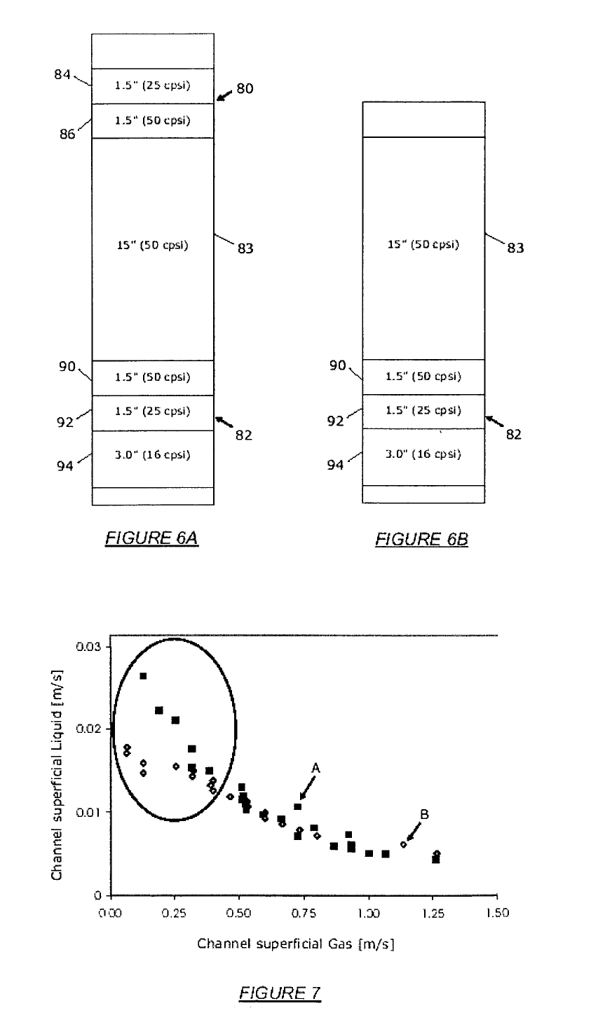

FIG. 6A shows a reactor configuration A which includes an inlet device 80 mounted at an inlet end of a monolith reactor bed 83. In this particular Example the reactor also comprises an outlet device 82 mounted at its outlet end, although the use of such an outlet device is entirely optional.

The inlet device 80 includes monolith segments 84, 86. The outlet device 82 includes monolith segments 90, 92, 94. The length and cell densities of the monoliths are indicated on the drawing. FIG. 6B shows a reactor configuration B which includes only the outlet device 80 at the outlet end of the monolith bed 83, i.e., there is no inlet device at the inlet end of the monolith bed 83.

FIG. 7 shows flooding limits as a function of superficial gas and liquid velocities for the reactor configurations A and B shown in FIGS. 6A and 6B, respectively. The results clearly show the improvement in flooding performance at higher liquid velocities when a flood limiting device is used at the inlet end of the monolith bed. At lower liquid velocities, both configurations behave similarly, indicating that liquid entrance phenomena do not dominate in this flow regime.

The invention provides a number of distinct advantages for the operation of most reactors or gas-liquid contactors of known design. In general, a monolith stack or other flood-limiting device such as described tends to decouple the flooding performance of the monolith bed or other packing used in the reactor or contactor from the reactive performance of the packing. This allows for more flexibility in selecting the appropriate geometry for the packing which will enhance the reactive performance of the reactor or contactor. Thus the channel diameter and shape and number of segments in a flood limit device consisting of a monolith stack can be selected to achieve a desired flooding performance independently of the bed design. An optional outlet device can be used to further improve the flooding performance of a monolith bed in a reactor or gas-liquid contactor if desired. Both inlet and outlet devices can also be used with non-monolithic counter-current reactors or contactors, such as packed beds and other structured packings.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention is limited only by the attached claims.

We claim:

1. A device for expanding a flooding limit of a packed column comprising:
one or a plurality of stacked channeled inlet structures positioned at the inlet to the column through which a liquid is conveyed into the column, the inlet to the device consisting of a segment having a larger or equal effective channel hydraulic diameter than the packing in the column,
whereby the device retards bridging of the liquid at the inlet of the packed column.

2. The device of claim 1, wherein the device comprises a stack incorporating a plurality of channeled honeycomb monolith segments of varying cell density, the segments having channels that decrease step-wise in effective hydraulic diameter through the stack in the direction of liquid flow into the column.

3. The device of claims 1, whereby the device has a larger void fraction compared to the packed bed, and preferably void fractions above 50%.

4. The device of claim 2, wherein the stack has a limited flow capacity in a non-flooded regime of the packed column.

5. A counter-current reactor, comprising:
a packed column; and
a flood-limiting device mounted at the inlet of the packed column comprising one or a plurality of stacked channeled inlet structures through which a liquid is conveyed into the inlet of the column, the device (i) including an inlet consisting of an structure having a larger effective channel hydraulic diameter than the packing in the column, and (ii) having a decreasing hydraulic diameter in the direction of liquid flow into the column.

6. The counter-current reactor of claim 5, wherein the flood-limiting device comprises a stack of monolith segments, the segments having channels that decrease step-wise in effective hydraulic diameter through the stack in the direction of liquid flow into the column.

7. The counter-current reactor of claim 5 further comprising a second stack of monolith segments mounted at an outlet of the packed column, the second stack having an increasing hydraulic diameter in the direction of fluid flow from the column.

8. The countercurrent reactor of claim 5, wherein the packed column contains honeycomb monolith packing.

9. The countercurrent reactor of claim 5, wherein the packed column contains a pelletized catalyst.

10. A method of extending the flooding limit of a packed column, comprising:
passing a fluid through a flood-limiting device mounted at the inlet of the packed column comprising one or a plurality of stacked channeled inlet structures through which a liquid is conveyed into the inlet of the column.

11. The method of claim 9 wherein the flood-limiting device comprises a stack of monolith segments, the segments having channels that decrease step-wise in effective hydraulic diameter through the stack in the direction of liquid flow into the column.

12. The method of claim 10, further comprising draining fluid from an outlet of the packed column through a second stack of monolith segments having an increasing hydraulic diameter.
